(19) United States
(12) Patent Application Publication
(10) Pub. No.: US 2022/0148487 A1
(43) Pub. Date: May 12, 2022

(54) DISPLAY DRIVING DEVICE

(71) Applicant: Wuhan China Star Optoelectronics Technology Co., Ltd., Wuhan Hubei (CN)

(72) Inventors: Jingfeng XUE, Wuhan Hubei (CN); Yong TIAN, Wuhan Hubei (CN); Lihua ZHENG, Wuhan Hubei (CN)

(73) Assignee: Wuhan China Star Optoelectronics Technology Co., Ltd., Wuhan Hubei (CN)

(21) Appl. No.: 16/607,103

(22) PCT Filed: May 20, 2019
(86) PCT No.: PCT/CN2019/087596

§ 371 Date: Dec. 19, 2021

(30) Foreign Application Priority Data
Apr. 29, 2019 (CN) 201910354637.3

(51) Int. Cl. G09G 3/20

(52) U.S. Cl. CPC G09G 3/2092; G09G 2320/0209; G09G 2310/0297; G09G 2310/061; G09G 2320/0247

(57) ABSTRACT

The present disclosure provides a display driving device, the display driving device including a driving module configured to periodically output driving time sequences, wherein each of the driving time sequences includes an execution time sequence and a blank time sequence; and an adjustment module configured to be connected to the driving module, wherein the adjustment module outputs adjusting time sequences to the driving module in a timing range of each of the blank time sequences. By the adjusting time sequences, a leakage of the display driving device is reduced.

### FIELD OF INVENTION

The present disclosure relates to the field of display technologies, and more particularly to a display driving device.

### BACKGROUND OF INVENTION

Current displays generally have a frequency of 60 Hz, that is, a screen of the current display is refreshed 60 times per second, so that pictures seen by human eyes is dynamic and smooth. In some application scenarios, in order to save power consumption of the current displays, the current displays need to be down-converted, for example, from 60 Hz to 30 Hz. In other scenarios, such as when performing high-frequency games, it is necessary to increase the frequency of the current display, for example, from 60 Hz to 90 Hz or 120 Hz, so that the picture is smoother. Therefore, in order to be suitable for different scenarios, the current display needs to change a display frequency, that is, display in dynamic frame rate.

When the display frequency of current display changes from high to low, a charging time of the current display does not change, but simply extends the blank time in the time sequence.

However, in this way, when the low frequency display increases the blank time in the time sequence, the leakage of the display increases, and causes the displays to flicker or crosstalk easily, which seriously affects imaging quality of the display.

Specifically, please refer to FIG. 1 and FIG. 2 together, which show a driving time sequence diagram of the current display driving device and a schematic diagram of a pixel circuit of the prior art respectively. As shown, a gate, a data multiplexer, and a source are all off during the blank time sequence.

When the gate is turned off, a voltage of an S point which connected data line is a voltage of a source of the turned off last data multiplexer. Since this voltage is indeterminate, a Vds voltage in the pixel circuit is uncertain. In other words, when the gate is turned off and the Vds voltage difference is greater, the leakage current of the pixel circuit also increased.

Therefore, there is a need to provide a display driving device to solve issues existing in the prior art.

### SUMMARY OF INVENTION

To solve the above problems, the present disclosure provides a display driving device, which can reduce the leakage time, and further improve problems of flicker and crosstalk.

To achieve the above objective, the present disclosure provides a display driving device. The display device including a driving module configured to periodically output driving time sequences, wherein each of the driving time sequences includes an execution time sequence and a blank time sequence; and an adjustment module configured to be connected to the driving module, wherein the adjustment module outputs adjusting time sequences to the driving module in a timing range of each of the blank time sequences.

In an embodiment of the present disclosure, wherein the driving module includes a first data multiplexer configured to output a first multiplex driving time sequence, wherein the first multiplex driving time sequence includes a first execution time sequence and a first blank time sequence. A second data multiplexer configured to output a second multiplex driving time sequence, wherein the second multiplex driving time sequence includes a second execution time sequence and a second blank time sequence. A third data multiplexer configured to output a third multiplex driving time sequence, wherein the third multiplex driving time sequence includes a third execution multiplexer time sequence and a third blank time sequence. Wherein the first execution time sequence, the second execution time sequence, and the third execution time sequence is outputted in a timing range of the execution time sequence, and the first blank time sequence, the second blank time sequence, and the third time sequence are outputted in a timing range of the blank time sequence.

In an embodiment of the present disclosure, wherein the driving module further includes a plurality of driving gates, when the driving module outputs the blank time sequence, the plurality of driving gates are turned off.

In an embodiment of the present disclosure, wherein the driving module further includes a plurality of driving gates, when the driving module outputs the blank time sequence, the plurality of driving gates are in a low potential state.

In an embodiment of the present disclosure, wherein the adjustment module includes: a first data multiplexer adjusting member connected to the first data multiplexer, the first data multiplexer adjusting member configured to output a first adjusting time sequence to the first data multiplexer; a second data multiplexer adjusting member connected to the second data multiplexer, the second data multiplexer adjusting member configured to output a second adjusting time sequence to the second data multiplexer; a third data multiplexer adjusting member connected to the third data multiplexer, the third data multiplexer adjusting member configured to output a third adjusting time sequence to the third data multiplexer; wherein the adjusting time sequence includes the first adjusting time sequence, the second adjusting time sequence, and the third adjusting time sequence; the first adjusting time sequence is outputted in a timing range of the first blank time sequence, the second adjusting time sequence is outputted in a timing range of the second blank time sequence, and the third adjusting time sequence is outputted in a timing range of the third blank time sequence.

In an embodiment of the present disclosure, wherein each of the adjusting time sequences is continuous with a previous execution time sequence.

In an embodiment of the present disclosure, wherein each of the adjusting time sequences is not continuous with the execution time sequence.

In an embodiment of the present disclosure, wherein each of the adjusting time sequences occupies each of the blank time sequences.

In an embodiment of the present disclosure, wherein the adjustment module is further configured to be connected to a source voltage adjustment device, the source voltage adjustment device is configured to output a source voltage adjustment signal, and the adjustment module adjusts a source adjustment voltage of the adjusting time sequence according to the source voltage adjustment signal.

In an embodiment of the present disclosure, wherein a value of the source adjustment voltage is configured to same as a value of an intermediate voltage of the execution time sequence.

In an embodiment of the present disclosure, wherein the first adjusting time sequence is not continuous with the first execution time sequence, the second adjusting time sequence is not continuous with the second execution time sequence, and the third adjusting time sequence is not continuous with the third execution time sequence.

In an embodiment of the present disclosure, wherein the first adjusting time sequence is continuous with the first execution time sequence, the second adjusting time sequence is continuous with the second execution time sequence, and the third adjusting time sequence is continuous with the third execution time sequence.

In an embodiment of the present disclosure, wherein each of the first adjusting time sequences occupies each of the first blank time sequences, each of the second adjusting time sequences occupies each of the second blank time sequences, and each of the third adjusting time sequences occupies each of the third blank time sequences.

To achieve the above objective, the present disclosure further provides a display driving device, including a driving module configured to periodically output driving time sequences, wherein each of the driving time sequences includes an execution time sequence and a blank time sequence; and an adjustment module configured to be connected to the driving module, the adjustment module outputs adjusting time sequences to the driving module in a timing range of each of the blank time sequences, each of the adjusting time sequences is continuous with previous the execution time sequence; wherein the adjustment module is further configured to be connected to a source voltage adjustment device, the source voltage adjustment device is configured to output a source voltage adjustment signal, and the adjustment module adjusts a source adjustment voltage of the adjusting time sequence according to the source voltage adjustment signal.

To achieve the above objective, the present disclosure further provides a display driving device, including a driving module configured to periodically output driving time sequences, wherein each of the driving time sequences includes an execution time sequence and a blank time sequence; and an adjustment module configured to be connected to the driving module, the adjustment module outputs adjusting time sequences to the driving module in a timing range of each of the blank time sequences, each of the adjusting time sequences is not continuous with previous the execution time sequence; wherein the adjustment module is further configured to be connected to a source voltage adjustment device, the source voltage adjustment device is configured to output a source voltage adjustment signal, and the adjustment module adjusts a source adjustment voltage of the adjusting time sequence according to the source voltage adjustment signal.

Compared with the prior art, the display driving device of embodiments of the present disclosure, the display driving device including a driving module configured to periodically output driving time sequences, wherein each of the driving time sequences includes an execution time sequence and a blank time sequence; and an adjustment module configured to be connected to the driving module, wherein the adjustment module outputs adjusting time sequences to the driving module in a timing range of each of the blank time sequences. By the adjusting time sequences reducing the leakage time, and further improve problems of flicker and crosstalk.

### DESCRIPTION OF DRAWINGS

FIG. 1 shows a driving time sequence diagram of the current display driving device.

FIG. 2 shows a schematic diagram of a pixel circuit of the prior art.

FIG. 3 shows a block schematic diagram of a display device according to an embodiment of the present disclosure.

FIG. 4 shows a driving time sequence schematic diagram of a display device according to an embodiment of the present disclosure.

FIG. 5 shows a driving time sequence schematic diagram of a display device according to an embodiment of the present disclosure.

FIG. 6 shows a driving time sequence schematic diagram of a display device according to an embodiment of the present disclosure.

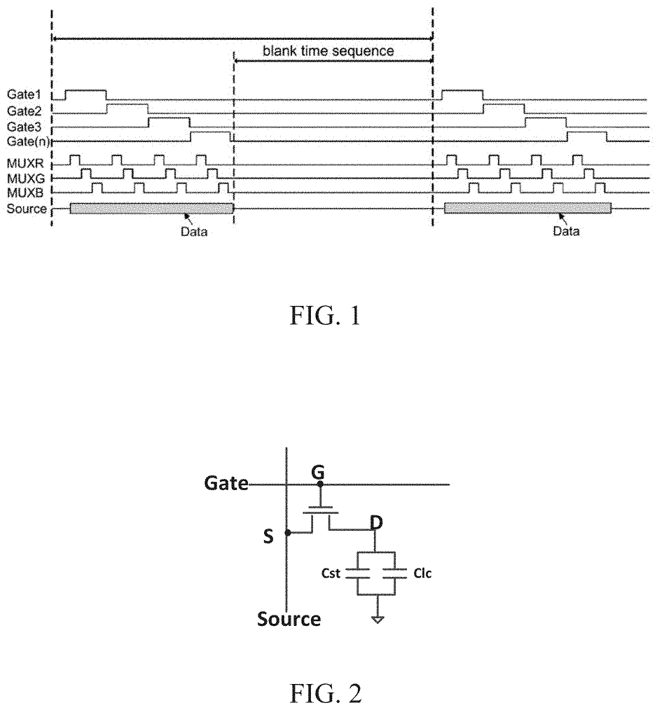

### DETAILED DESCRIPTION OF PREFERRED EMBODIMENTS

In order to make the above description of the present disclosure and other objects, features, and advantages of the present disclosure more comprehensible, preferred embodiments are described below, and are described in detail below with reference to the accompanying drawings. Furthermore, directional terms described by the present disclosure, such as up, down, top, bottom, front, back, left, right, inner, outer, side, surrounding, center, horizontal, vertical, longitudinal, axial, radial, uppermost or lowermost, etc., are only directions by referring to the accompanying drawings, and thus the used terms are used only for the purpose of describing embodiments of the present disclosure and are not intended to be limiting of the present disclosure.

In the drawings, units with similar structures are labeled with the same reference number.

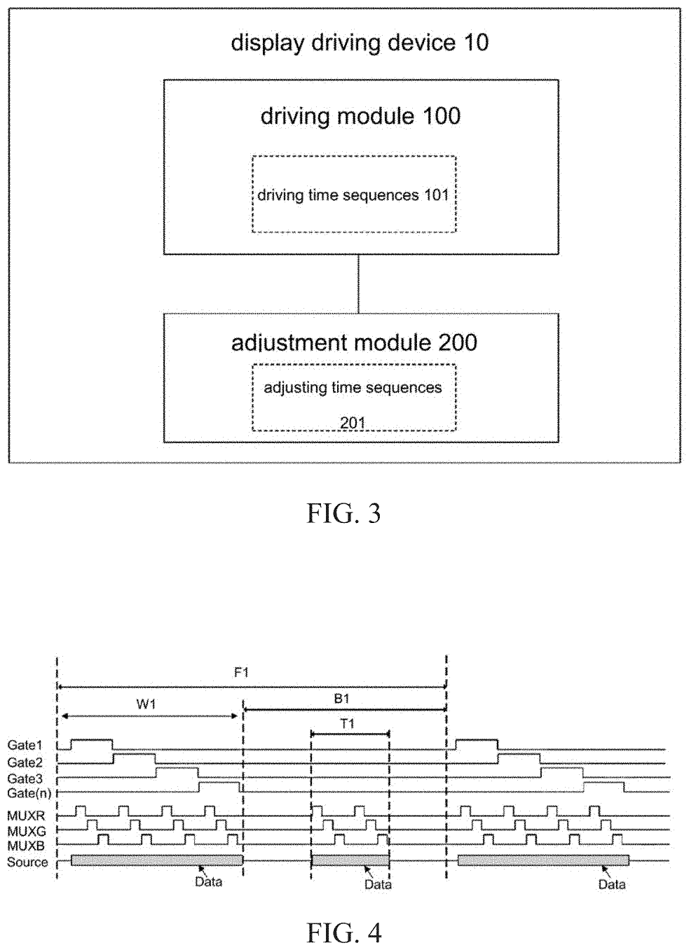

Please refer to FIG. 3, which shows a block schematic diagram of a display device according to an embodiment of the present disclosure. As shown in figure, the present disclosure provides a display driving device 10. The display driving device 10 including a driving module 100 configured to periodically output driving time sequences 101, wherein each of the driving time sequences 101 includes an execution time sequence and a blank time sequence; and an adjustment module 200 configured to be connected to the driving module 100, wherein the adjustment module 200 outputs adjusting time sequences 201 to the driving module 100 in a timing range of each of the blank time sequences.

Wherein, the driving sequence 101 may be composed of a plurality of driving time sequences of data multiplexers, and the number of the driving time sequence of data multiplexer is determined according to applicable of image complexity and environmental requirements. Further descriptions of the present disclosure will be described with three data multiplexers.

Wherein, in some of the below embodiments, a first data multiplexer MUXR can be a data multiplexer configured to output red signal, a second data multiplexer MUXG can be a data multiplexer configured to output green signal, and a third data multiplexer MUXB can be a data multiplexer configured to output blue signal.

Please refer to FIG. 4 to FIG. 6, in an embodiment of the present disclosure, the display driving device includes the first data multiplexer MUXR configured to output a first multiplex driving time sequence, wherein the first multiplex driving time sequence includes a first execution time sequence and a first blank time sequence; the second data multiplexer MUXG configured to output a second multiplex driving time sequence, wherein the second multiplex driving time sequence includes a second execution time sequence and a second blank time sequence; the third data multiplexer configured to output a third multiplex driving time sequence, wherein the third multiplex driving time sequence includes a third execution multiplexer time sequence and a third blank time sequence. Wherein the first execution time sequence, the second execution time sequence, and the third execution time sequence are outputted in a timing range of the execution time sequence, and wherein the first blank time sequence, the second blank time sequence, and the third blank time sequence are outputted in a timing range of the blank time sequence.

In an embodiment of the present disclosure, wherein the driving module further includes a plurality of driving gates including a first gate Gate1 configured to output a first gate time sequence, a second gate Gate2 configured to output a second gate time sequence, and a third gate Gate3 configured to output a third gate time sequence. The number of the driving gates is not limited to three, as shown in figure, there are from 1st to Nth, wherein the Nth gate Gate(n) configured to output an Nth gate time sequence.

When the driving module outputs the blank time sequence, the plurality of driving gates including the first gate Gate1, the second gate Gate2, and the third gate Gate3 to the Nth gate Gate(n) are turned off or in a low potential state.

In an embodiment of the present disclosure, wherein the adjustment module includes a first data multiplexer adjusting member connected to the first data multiplexer, the first data multiplexer adjusting member configured to output a first adjusting time sequence to the first data multiplexer; a second data multiplexer adjusting member connected to the second data multiplexer, the second data multiplexer adjusting member configured to output a second adjusting time sequence to the second data multiplexer; a third data multiplexer adjusting member connected to the third data multiplexer, the third data multiplexer adjusting member configured to output a third adjusting time sequence to the third data multiplexer; wherein the adjusting time sequence includes the first adjusting time sequence, the second adjusting time sequence, and the third adjusting time sequence; wherein the first adjusting time sequence is outputted in a timing range of the first blank time sequence, the second adjusting time sequence is outputted in a timing range of the second blank time sequence, and the third adjusting time sequence is outputted in a timing range of the third blank time sequence.

Please refer to FIG. 4, which shows a driving time sequence schematic diagram of a display device according to an embodiment of the present disclosure. As shown in figure, which disclosed time sequence schematic diagram of a driving time sequence F1, a blank time sequence B1, and an adjustment time sequence T1 which are corresponds to the first gate Gate1, the second gate Gate2, and the third gate Gate3 to the Nth gate Gate(n), the first data multiplexer MUXR, the second data multiplexer MUXG, the third data multiplexer MUXB and the source respectively.

In an embodiment shown in FIG. 4, wherein the adjusting time sequence T1 is not continuous with the execution time sequence W1. Specifically, a timing range of the adjusting time sequence T1 includes a first adjusting time sequence of the first data multiplexer MUXR, a second adjusting time sequence of the second data multiplexer MUXG, and a third adjusting time sequence of the third data multiplexer MUXB. In other words, the first adjusting time sequence of the first data multiplexer MUXR is not continuous with the first execution time sequence, the second adjusting time sequence of the second adjusting time sequence of the second data multiplexer MUXG is not continuous with the second execution time sequence, the third adjusting time sequence of the third data multiplexer MUXB is not continuous with the third execution time sequence, by output the adjusting time sequence to reduce the Vds voltage difference and the leakage current of the pixel circuit.

Furthermore, in a timing range of the blank time sequence B1, the first gate Gate1, the second gate Gate2, and the third gate Gate3 to the Nth gate Gate(n) are output smooth signal. That is, the first gate Gate1, the second gate Gate2, and the third gate Gate3 to the Nth gate Gate(n) are turned off or in a low potential state.

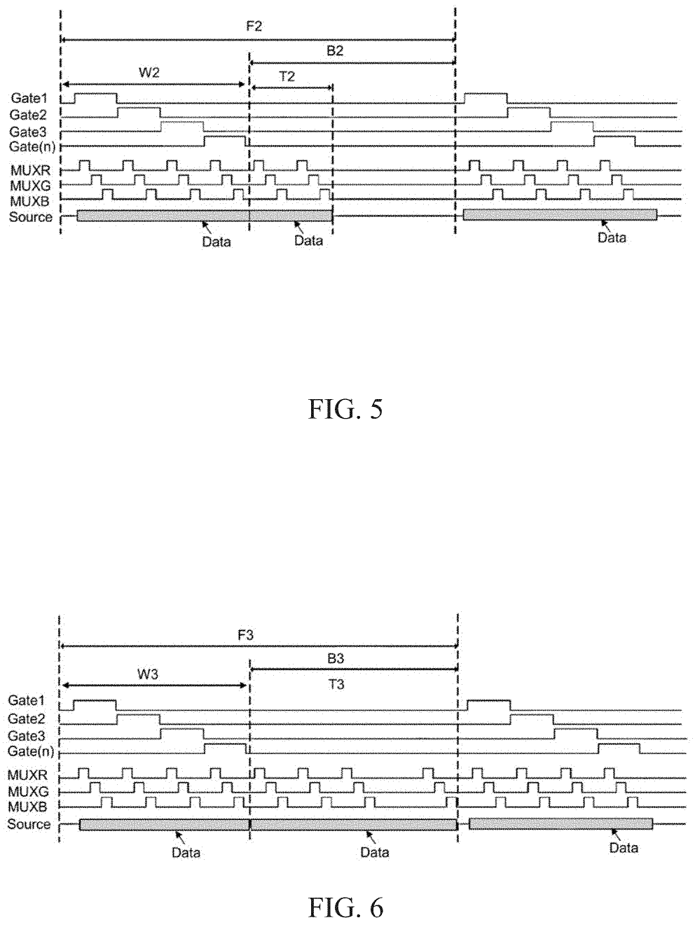

Please refer to FIG. 5, which shows a driving time sequence schematic diagram of a display device according to an embodiment of the present disclosure. As shown in figure, which disclosed time sequence schematic diagram of a driving time sequence F2, a blank time sequence B2, and an adjustment time sequence T2 which are corresponds to the first gate Gate1, the second gate Gate2, and the third gate Gate3 to the Nth gate Gate(n), the first data multiplexer MUXR, the second data multiplexer MUXG, the third data multiplexer MUXB and the source respectively.

In this embodiment, the adjusting time sequence T2 is continuous with previous execution time sequence W2. Specifically, a timing range of the adjusting time sequence T2 includes a first adjusting time sequence of the first data multiplexer MUXR, a second adjusting time sequence of the second data multiplexer MUXG, and a third adjusting time sequence of the third data multiplexer MUXB. In other words, the first adjusting time sequence of the first data multiplexer MUXR is continuous with the first execution time sequence, the second adjusting time sequence of the second adjusting time sequence of the second data multiplexer MUXG is continuous with the second execution time sequence, the third adjusting time sequence of the third data multiplexer MUXB is continuous with the third execution time sequence, by output the adjusting time sequence to reduce the Vds voltage difference and the leakage current of the pixel circuit.

Please refer to FIG. 6, which shows a driving time sequence schematic diagram of a display device according to an embodiment of the present disclosure. As shown in figure, which disclosed time sequence schematic diagram of a driving time sequence F3, a blank time sequence B3, and an adjustment time sequence T3 which are corresponds to the first gate Gate1, the second gate Gate2, and the third gate Gate3 to the Nth gate Gate(n), the first data multiplexer MUXR, the second data multiplexer MUXG, the third data multiplexer MUXB and the source respectively.

In this embodiment, the adjusting time sequence T3 includes a first adjusting time sequence of the first data multiplexer MUXR, a second adjusting time sequence of the second data multiplexer MUXG, and a third adjusting time sequence of the third data multiplexer MUXB. In other words, the first adjusting time sequence of the first data multiplexer MUXR occupies the first execution time sequence, the second adjusting time sequence of the second adjusting time sequence of the second data multiplexer MUXG occupies the second execution time sequence, the third adjusting time sequence of the third data multiplexer MUXB occupies the third execution time sequence, by output the adjusting time sequence to reduce the Vds voltage difference and the leakage current of the pixel circuit.

In an embodiment of the present disclosure, the adjustment module is further configured to be connected to a source voltage adjustment device, the source voltage adjustment device is configured to output a source voltage adjustment signal, and the adjustment module adjusts a source adjustment voltage of the adjusting time sequence according to the source voltage adjustment signal.

In an embodiment of the present disclosure, a value of the source adjustment voltage is configured to same as a value of an intermediate voltage of the execution time sequence. In the following description further describe the intermediate voltage.

In an embodiment of the present disclosure, a value of the intermediate voltage is an average of a value of a highest voltage and a value of a lowest voltage in the previous execution time sequence. For example, a positive frame of the display device is about 2.5V, a negative frame is about −2.5V, and the intermediate voltage is 0V.

In an embodiment of the present disclosure, a value of the intermediate voltage is an intermediate value in a range of a positive frame voltage or an intermediate value in a range of a negative frame voltage. For example, the range of the positive frame voltage is 0-5V, the intermediate voltage is 2.5V; the range of the positive frame voltage is −5-0V, the intermediate voltage is −2.5V.

In an embodiment of the present disclosure, the intermediate voltage is a value of a voltage at an intermediate time of a previous execution time sequence. In an embodiment with a plurality of data multiplexers of the present disclosure, a value of the intermediate voltage is an average of a value of a highest voltage in a previous execution time sequence and a value of a lowest voltage in a previous execution time sequence.

In an embodiment with a plurality of data multiplexers of the present disclosure, a value of the intermediate voltage is an average value of voltages of each of the data multiplexers at the intermediate time point of the previous execution time sequence.

In an embodiment of the present disclosure, the source adjustment voltage can be adjusted to other values other than a value of the intermediate voltage according to the display frequency and the application scenarios.

In an embodiment of the present disclosure, when the display is adapted to perform high frequency display, the source adjustment voltage be adjusted to be higher than an average of a value of a highest voltage and a value of a lowest voltage in the previous execution time sequence by making the adjusted source adjustment voltage close to the value of the highest voltage of the previous execution time sequence. To further reduce the leakage current of the display.

In another embodiment of the present disclosure, when the display is adapted to perform low frequency display, the source adjustment voltage be adjusted to be lower than an average of a value of a highest voltage and a value of a lowest voltage in the previous execution time sequence by making the adjusted source adjustment voltage close to the value of the lowest voltage of the previous execution time sequence. To further reduce the leakage current of the display, and achieve the energy saving effect.

In summary, because of the display driving device of embodiments of the present disclosure, the display driving device including a driving module configured to periodically output driving time sequences, wherein each of the driving time sequences includes an execution time sequence and a blank time sequence; and an adjustment module configured to be connected to the driving module, wherein the adjustment module outputs adjusting time sequences to the driving module in a timing range of each of the blank time sequences. In an aspect, by the adjusting time sequences reducing the leakage of the display, and maintains charging while outputting the blank time sequence, further reduce the voltage difference between the blank time sequence and the execution time sequence, and improve problems of flicker and crosstalk.

Although the present disclosure is described via one or more embodiments, those of ordinary skill in the art can come up with equivalent variations and modifications based upon the understanding of the specification and the accompanying drawings. The present disclosure includes all such modifications and variations, and is only limited by the scope of the appended claims. In particular, as to the various functions performed by the components described above, the terms used to describe the components are intended to correspond to any component performing the specific functions (e.g., which are functionally equivalent) of the components (unless otherwise indicated), even those which are structurally different from the disclosed structure for performing the functions in the exemplary embodiments in the specification shown herein. In addition, although a particular feature in the specification is disclosed in only one of many embodiments, this feature may be combined with one or more features in other embodiments which are desirable and advantageous to a given or particular application. Moreover, the terms “include”, “have”, “consist of”, or variations thereof used in the detailed description or the claims are intended to be used in a manner similar to the term “comprising”.

The above are only preferred embodiments of the present disclosure, and it should be noted that those skilled in the art can also make several improvements and refinements without departing from the principles of the present disclosure. These improvements and refinements should also be considered in a protected range of the present disclosure.

What is claimed is:

1. A display driving device, comprising:
a driving module configured to periodically output driving time sequences, wherein each of the driving time sequences comprises an execution time sequence and a blank time sequence; and
an adjustment module configured to be connected to the driving module, wherein the adjustment module outputs adjusting time sequences to the driving module in a timing range of each of the blank time sequences.

2. The display driving device according to claim 1, wherein the driving module comprises:
a first data multiplexer configured to output a first multiplex driving time sequence, wherein the first multiplex driving time sequence comprises a first execution time sequence and a first blank time sequence;
a second data multiplexer configured to output a second multiplex driving time sequence, wherein the second multiplex driving time sequence comprises a second execution time sequence and a second blank time sequence;
a third data multiplexer configured to output a third multiplex driving time sequence, wherein the third multiplex driving time sequence comprises a third execution multiplexer time sequence and a third blank time sequence;
wherein the first execution time sequence, the second execution time sequence, and the third execution time sequence are outputted in a timing range of the execution time sequence, and wherein the first blank time sequence, the second blank time sequence, and the third time sequence are outputted in a timing range of the blank time sequence.

3. The display driving device according to claim 2, wherein the driving module further comprises a plurality of driving gates, when the driving module outputs the blank time sequence, the plurality of driving gates are turned off.

4. The display driving device according to claim 2, wherein the driving module further comprises a plurality of driving gates, when the driving module outputs the blank time sequence, the plurality of driving gates are in a low potential state.

5. The display driving device according to claim 2, wherein the adjustment module comprises:
a first data multiplexer adjusting member connected to the first data multiplexer, the first data multiplexer adjusting member configured to output a first adjusting time sequence to the first data multiplexer;
a second data multiplexer adjusting member connected to the second data multiplexer, the second data multiplexer adjusting member configured to output a second adjusting time sequence to the second data multiplexer;
a third data multiplexer adjusting member connected to the third data multiplexer, the third data multiplexer adjusting member configured to output a third adjusting time sequence to the third data multiplexer;
wherein the adjusting time sequence comprises the first adjusting time sequence, the second adjusting time sequence, and the third adjusting time sequence; wherein the first adjusting time sequence is outputted in a timing range of the first blank time sequence, the second adjusting time sequence is outputted in a timing range of the second blank time sequence, and the third adjusting time sequence is outputted in a timing range of the third blank time sequence.

6. The display driving device according to claim 1, wherein each of the adjusting time sequences is continuous with a previous execution time sequence.

7. The display driving device according to claim 1, wherein each of the adjusting time sequences is not continuous with the execution time sequence.

8. The display driving device according to claim 1, wherein each of the adjusting time sequences occupies each of the blank time sequences.

9. The display driving device according to claim 1, wherein the adjustment module is further configured to be connected to a source voltage adjustment device, the source voltage adjustment device is configured to output a source voltage adjustment signal, and the adjustment module adjusts a source adjustment voltage of the adjusting time sequence according to the source voltage adjustment signal.

10. The display driving device according to claim 9, wherein the source adjustment voltage is configured to same as a value of an intermediate voltage of the execution time sequence.

11. The display driving device according to claim 5, wherein the first adjusting time sequence is not continuous with the first execution time sequence, the second adjusting time sequence is not continuous with the second execution time sequence, and the third adjusting time sequence is not continuous with the third execution time sequence.

12. The display driving device according to claim 5, wherein the first adjusting time sequence is continuous with the first execution time sequence, the second adjusting time sequence is continuous with the second execution time sequence, and the third adjusting time sequence is continuous with the third execution time sequence.

13. The display driving device according to claim 5, wherein each of the first adjusting time sequences occupies each of the first blank time sequences, each of the second adjusting time sequences occupies each of the second blank time sequences, and each of the third adjusting time sequences occupies each of the third blank time sequences.

14. A display driving device, comprising:
a driving module configured to periodically output driving time sequences, wherein each of the driving time sequences comprises an execution time sequence and a blank time sequence; and
an adjustment module configured to be connected to the driving module, the adjustment module outputs adjusting time sequences to the driving module in a timing range of each of the blank time sequences, each of the adjusting time sequences is continuous with previous the execution time sequence;
wherein the adjustment module is further configured to be connected to a source voltage adjustment device, the source voltage adjustment device is configured to output a source voltage adjustment signal, and the adjustment module adjusts a source adjustment voltage of the adjusting time sequence according to the source voltage adjustment signal.

15. The display driving device according to claim 14, wherein the driving module comprises:
a first data multiplexer configured to output a first multiplex driving time sequence, wherein the first multiplex driving time sequence comprises a first execution time sequence and a first blank time sequence;
a second data multiplexer configured to output a second multiplex driving time sequence, wherein the second multiplex driving time sequence comprises a second execution time sequence and a second blank time sequence;
a third data multiplexer configured to output a third multiplex driving time sequence, wherein the third multiplex driving time sequence comprises a third execution multiplexer time sequence and a third blank time sequence;
wherein the first execution time sequence, the second execution time sequence, and the third execution time sequence are outputted in a timing range of the execution time sequence, and wherein the first blank time sequence, the second blank time sequence, and the third time sequence are outputted in a timing range of the blank time sequence.

16. The display driving device according to claim 14, wherein the adjustment module comprises:
a first data multiplexer adjusting member connected to the first data multiplexer, the first data multiplexer adjusting member configured to output a first adjusting time sequence to the first data multiplexer;
a second data multiplexer adjusting member connected to the second data multiplexer, the second data multiplexer adjusting member configured to output a second adjusting time sequence to the second data multiplexer; and
a third data multiplexer adjusting member connected to the third data multiplexer, the third data multiplexer adjusting member configured to output a third adjusting time sequence to the third data multiplexer.

17. The display driving device according to claim 14, wherein a value of source adjustment voltage is configured to same as a value of an intermediate voltage of the execution time sequence.

18. A display driving device, comprising:
a driving module configured to periodically output driving time sequences, wherein each of the driving time sequences comprises an execution time sequence and a blank time sequence; and
an adjustment module configured to be connected to the driving module, the adjustment module outputs adjusting time sequences to the driving module in a timing range of each of the blank time sequences, each of the adjusting time sequences is not continuous with previous the execution time sequence;
wherein the adjustment module is further configured to be connected to a source voltage adjustment device, the source voltage adjustment device is configured to output a source voltage adjustment signal, and the adjustment module adjusts a source adjustment voltage of the adjusting time sequence according to the source voltage adjustment signal.

19. The display driving device according to claim 18, wherein the adjustment module comprises:
a first data multiplexer adjusting member connected to the first data multiplexer, the first data multiplexer adjusting member configured to output a first adjusting time sequence to the first data multiplexer;
a second data multiplexer adjusting member connected to the second data multiplexer, the second data multiplexer adjusting member configured to output a second adjusting time sequence to the second data multiplexer; and
a third data multiplexer adjusting member connected to the third data multiplexer, the third data multiplexer adjusting member configured to output a third adjusting time sequence to the third data multiplexer.

20. The display driving device according to claim 18, wherein a value of the source adjustment voltage is configured to same as a value of an Intermediate voltage of the execution time sequence.
